(19) United States
(12) Patent Application Publication
(10) Pub. No.: US 2013/0220531 A1
(43) Pub. Date: Aug. 29, 2013

(54) METHOD FOR RECORDING GLOSSY IMAGE

(71) Applicant: Seiko Epson Corporation, (US)

(72) Inventor: Masakazu OHASHI, Shiojiri (JP)

(73) Assignee: Seiko Epson Corporation, Tokyo (JP)

(21) Appl. No.: 13/775,596

(22) Filed: Feb. 25, 2013

(30) Foreign Application Priority Data
Feb. 27, 2012 (JP) 2012-039677

(51) Int. Cl. B41M 7/00

(52) U.S. Cl. CPC B41M 7/0027
USPC 156/247

(57) ABSTRACT

A recording method includes a method for recording a glossy image on a recording medium of which a recording surface includes a recording portion having the glossy image recorded and a non-recording portion having the glossy image non-recorded. The method includes the steps of attaching a resin-containing masking composition to the non-recording portion; attaching an adhesive composition to the recording portion by an ink jet method; bringing the recording medium into contact with a glossy film-formed sheet such that the recording surface of the recording medium faces the glossy film-formed surface of the sheet, heating the adhesive composition; and peeling off the recording medium and the sheet.

Priority is claimed under 35 U.S.C. §119 to Japanese Application No. 2012-039677 filed on Feb. 27, 2012, which is hereby incorporated by reference in its entirety.

### BACKGROUND

1. Technical Field

The present invention relates to a method for recording glossy image.

2. Related Art

Recently, a demand for recording materials forming the image which has a gloss property on a recording surface has increased. Examples of the known methods forming the image which has a gloss property include a method of preparing a recording medium having a recording surface with high flatness and of pressing and recording metal foils; a method of subjecting a plastic film of which the recording surface is flat to vacuum deposition of metals or the like in the past; and a method of coating a recording medium with glossy pigment ink. With respect to a method of transferring metal foils onto a recording medium to form an image, for example, JP-A-2009-226863 discloses a method of forming image of foils to a recording medium using a pressure sensitive adhesive.

A method where a deposited glossy film previously formed so as to impart a flatness on the surface of the film is transferred onto a recording medium to obtain glossy image is preferable because the transferred image has an excellent gloss property as compared to other methods. This method includes the process where an adhesive is attached to a recording medium to bring the adhesive into contact with the deposited film, from which the image is transferred onto the recording medium.

However, when the recording surface of the recording medium is coated with resin-containing materials, a problem where the image is also transferred onto regions other than desirable regions in the transferring process may occur depending on types of the recording mediums.

### SUMMARY

An advantage of some aspects of the invention is that a recording method of a glossy image is provided to accurately and easily form an good glossy image with respect to a recording medium.

The invention can be realized in the following forms or application examples.

### Application Example 1

According to Application Example 1, there is provided a method for recording a glossy image on a recording medium of which a recording surface includes a recording portion having the glossy image recorded and a non-recording portion having the glossy image non-recorded, the method includes the steps of attaching a resin-containing masking composition to the non-recording portion, attaching an adhesive composition to the recording portion by an ink jet method, bringing the recording medium into contact with a glossy film-formed sheet such that the recording surface of the recording medium faces the glossy film-formed surface of the sheet, heating the adhesive composition, and peeling off the recording medium and the sheet.

According to the recording method of the Application Example, the glossy film may be accurately transferred onto the recording portion of the recording medium, and transfer of the glossy film onto the non-recording portion of the recording medium may be suppressed. Thereby, good glossy image may be accurately and easily formed on the recording medium.

### Application Example 2

In the method according to Application Example 1, the adhesive composition contains an adhesive compound and the adhesive compound may have a glass transition temperature of −10° C. or higher and 70° C. or lower.

According to the recording method of the Application Example, at a more practical glass transition temperature, the glossy film may be transferred onto the recording portion of the recording medium and transfer of the glossy film onto the non-recording portion of the recording medium may be suppressed.

### Application Example 3

In the method according to Application Example 1 or 2, the masking composition may contain the resin of 3% by mass or more.

According to the recording method of the Application Example, when the masking composition is attached by an ink jet method, the resin is easily applied on the surface of the non-recording portion, a masking effect may further increase, the glossy film may be transferred onto the recording portion of the recording medium, and transfer of the glossy film onto the non-recording portion of the recording medium may be suppressed.

### Application Example 4

In the method according to Application Example 3, the resin may have a glass transition temperature of 70° C. or higher.

According to the recording method of the Application Example, the glass transition temperature of the resin is easily higher than that of the adhesive compound, and thus a masking effect may further increase, the glossy film may be accurately transferred onto the recording portion of the recording medium, and transfer of the glossy film onto the non-recording portion of the recording medium may be suppressed.

### Application Example 5

In the method according to Application Example 3 or 4, the resin is at least one of acryl-based, urethane-based, and polyester-based, and incorporated as emulsion in the masking composition.

According to the recording method of the Application Example, masking effect may further increase, and glossy film may be accurately transferred onto the recording portion of the recording medium, and transfer of the glossy film onto the non-recording portion of the recording medium may be suppressed.

### Application Example 6

In the method according to any one of Application Examples 1 to 5, the recording surface of the recording medium is a coat layer, and the coat layer may contain materials having a glass transition temperature of 70° C. or lower.

According to the recording method of the Application Example, the glossy film may be transferred onto the recording portion of the recording medium, and transfer of the glossy film onto the non-recording portion of the recording medium may be suppressed.

### Application Example 7

In the method according to any one of Application Examples 1 to 6, further including a drying step between the step attaching the adhesive composition and the step bringing the recording medium into contact with the sheet, in which in the drying step, the amount of the adhesive composition attached to the recording medium may be reduced by 40% or more and 95% or less.

According to the recording method of the Application Example, the glossy film may be surely transferred onto the recording portion of the recording medium.

### Application Example 8

In the method according to any one of Application Examples 1 to 7, the masking composition may be attached to the non-recording portion by an ink jet method without substantial incorporation of coloring materials.

According to the recording method of the Application Example, the amount of the masking composition may be reduced.

### BRIEF DESCRIPTION OF THE DRAWINGS

The invention will be described with reference to the accompanying drawings, wherein like numbers reference like elements.

FIG. 1 is a schematic view illustrating a process of the recording method according to the present embodiment;

FIG. 2 is a schematic view illustrating a process of the recording method according to the present embodiment;

FIG. 3 is a schematic view illustrating a process of the recording method according to the present embodiment;

FIG. 4 is a schematic view illustrating a process of the recording method according to the present embodiment;

FIG. 5 is a flow chart showing an example of the recording method according to the present embodiment;

FIG. 6 is a flow chart showing an example of the recording method according to the present embodiment;

FIG. 7 is a schematic view showing an example of the recording device according to the present embodiment.

### DESCRIPTION OF EXEMPLARY EMBODIMENTS

Some embodiments of the invention will be described below. The present embodiment will be described below by way of an example of the invention. The invention is not specifically limited to these embodiments, various modifications and variations are possible without departing the gist of the invention. The required components of the invention are not limited to the whole components described in the following embodiments.

### 1. Explanation of Constitution and Terminology

### 1.1. Glossy Image

The glossy image recorded by the recording method according to the present embodiment has a gloss property. The gloss property may be evaluated by the specular gloss of image (see Japan Industrial Standards (JIS) Z8741).

### 1.2. Ink Jet Method

An ink jet method refers to a recording method by an ink jet recording mode. Examples of the recording methods include a mode applying strong electric effect to between a nozzle and an accelerating electrode in front of the nozzle, continuously ejecting, in the droplet shape, inks from the nozzle, and giving and recording a printing information signal to a deflecting electrode while ink droplets fly to between the deflecting electrodes, or a mode ejecting ink droplets in accordance with printing information signal without deflection of the ink droplets (electrostatic absorption mode); a mode applying pressure on ink liquid with a small pump, forcibly ejecting ink droplets while a nozzle is mechanically vibrated by a quartz vibrator or the like and applying pressure and printing information signal on ink liquid by a piezoelectric element and ejecting and recording ink droplets (Piezo mode); and a mode of heating and foaming ink liquid in a microelectrode in accordance with printing information signal and ejecting and recording ink droplet (thermal jet mode).

The ink jet method for the recording method according to the present embodiment may be carried out by an ink jet recording device including an ink jet recording head, a main body, a tray, a head drive, carriage, or the like, for example. The ink jet recording head may be configured to print a full color image, which is provided with an ink cartridge containing an ink set of at least four colors of cyan, magenta, yellow, and black. In the present embodiment, at least one of the ink cartridges may be placed to charge the following masking composition or adhesive composition. A cartridge other than the ink cartridge may be charged with general inks. The ink recording device is provided with dedicated control board or the like therein, and ink ejecting timing of the ink jet recording head, scanning of the head drive, and movement of the recording medium may be controlled.

The ink jet method need not perform a blocks preparing process, and desirable images may be easily formed in a constitution of a relatively small device, and therefore redundant use of the masking composition or adhesive composition may be reduced.

### 1.3. Recording Medium

Examples of the recording mediums for the recording method according to the present embodiment are not particularly limited. Examples of the recording medium include a variety of paper, fabrics, films, sheets and the like. More specifically, examples thereof include paper described in Japanese Industrial Standards JIS-P0001, fabrics described in JIS-L0206, non-woven fabrics described in JIS-L0222, and films or sheets composed of materials such as polyethylene terephthalate (PET), polybutylene terephthalate (PBT), polycarbonate, polyethylene naphthalate, polyester, polyethylene, polypropylene, acrylic resins, polystyrene, polyvinyl chloride, polyvinyl acetate, polyvinyl alcohol, polyether ether ketone, polyamide, polyethersulfone, polydiacetate, triacetate, polyimide, woods, metals, ceramics and glasses. In addition, the recording medium 10 may be coating papers such as a coat paper or art paper.

Examples of the commercially available recording mediums include pearl coated paper (manufactured by Mitsubishi Paper Co., Ltd.), aurora coated paper (manufactured by Nippon Paper Industries Co., Ltd.), photo paper chrisphere (manufactured by Seiko Epson Corporation), photo paper <gloss> (manufactured by Seiko Epson Corporation), photo paper entry (manufactured by Seiko Epson Corporation), photo gloss paper (manufactured by Seiko Epson Corporation) and the like.

The exemplified recording mediums are categorized by the surface properties thereof as follows: a recording medium which has an ink-absorbency, and a recording medium having no ink-absorbency or low ink-absorbency. The ink absorbency of the recording medium may be evaluated in accordance with Bristow's method. A phrase “recording medium substantially having no ink-absorbency” refers to a recording medium whose recording surface absorbs water of 10 mL/m² or less from contact initiation to 30 msec^{1/2}, in accordance with Bristow's method.

This Bristow's method is the most general method for measuring an absorbed liquid amount for a short period of time and is also adopted by the Japan Technical Association of the Pulp and Paper Industry (JAPAN TAPPI). Details of the test method are described in “JAPAN TAPPI paper and pulp test method, 2000” No. 51 “Paper and paperboard-liquid absorbance test method, Bristow's Method”.

For the purpose of ink fixing and ink absorbing, examples of types of the recording mediums include a recording medium coating the recording surface. Example of this type of the recording medium includes a recording medium having a coat layer on the recording surface such as a PET film and a polypropylene film. The coat layer includes inorganic materials such as silica and calcium carbonate, and polymer materials such as acryl-based resin and urethane-based resin. In particular, the recording surface of the recording medium is a coat layer. In a case where the coat layer contains materials having a glass transition temperature (Tg) of 70° C. or lower, when the glossy film is transferred onto the recording portion of the recording medium, the glossy film may be transferred onto the non-recording portion. Therefore, in the recording method according to the present embodiment, there is a remarkable effect where transfer of the glossy film onto the non-recording portion of the recording medium is suppressed.

The recording surface of the recording medium includes a recording portion having the glossy image recorded and a non-recording portion having glossy image non-recorded. The recording surface of the recording portion and non-recording portion has any size and shape. In addition, the recording portion and non-recording portion are complementarily divided in the whole recording surface. Therefore, according to the recording method according to the present embodiment, the glossy image is recorded on the recording portion in the recording surface of the recording medium.

### 1.4. Glossy Film-Formed Sheet

Examples of the glossy film-formed sheets include a film with a gloss property of an alloy of one or more selected from the group consisting of aluminum, silver, gold, platinum, nickel, chromium, tin, zinc, indium, titanium and copper formed on the surface of a plastic film (sheet) such as films composed of materials such as polyethylene terephthalate (PET), polybutylene terephthalate (PBT), polycarbonate, polyethylene naphthalate, polyester, polyethylene, polypropylene, acrylic resins, polystyrene, polyvinyl chloride, polyvinyl acetate, polyvinyl alcohol, polyether ether ketone, polyamide, polyethersulfone, polydiacetate, triacetate, polyimide.

The glossy film-formed sheet may be produced by forming a metal film on the surface of the sheet by deposition, or sputtering. The glossy film-formed sheet to be used may be commercially available products. In order to easily remove the glossy film from the sheet, the glossy film-formed sheet may be subjected to surface (interface) treatment and have a layer for ease removal.

### 2. Composition

### 2.1. Masking Composition

The masking composition to be attached to the recording medium contains resins. The masking composition may contain coloring materials. When the masking composition substantially has no coloring materials, the composition may be referred to as a clear ink. The masking composition may be water-based or solvent-based (non-water-based). It is preferable that the masking composition substantially has no coloring material. A phrase “substantially has no coloring material” refers to the coloring material having a content of 0.1% by mass or less, preferably 0.01% by mass or less, more preferably 0.001% by mass or less, and most preferably 0% by mass or less, as described below in a chapter “2.1.2.1 coloring material”.

### 2.1.1. Resin

The masking composition according to the present embodiment contains resins. Examples of the resins include styrene-acryl acid copolymer, styrene-methacrylic acid copolymer, polystyrene, styrene-acrylamide copolymer, ethylene-vinyl acetate copolymer, vinyl acetate-acryl copolymer, or the like. The resin may be included as a solution state or emulsion (particle dispersion) state in the masking composition. When the resin is incorporated in the masking composition in emulsion state, a masking effect caused by the masking composition may be increased. The glossy film may be transferred onto the recording portion of the recording medium, and transfer of the glossy film onto the non-recording portion of the recording medium may be suppressed.

When the resin is used as a particle dispersion, the resin particle has, in terms of volume, an average particle size of 20 nm or more and 300 nm or less, for example. According to the resin particle, when the masking composition is applied on the recording medium, a resin particle-concentrated layer may be formed on the surface. Thereby, an effect imparting good gloss or luster to the formed image, and an effect suppressing permeation of an adhesive composition into the recording medium when the adhesive composition is caused to be attached to the masking composition may be expected.

The resin incorporated in the masking composition has a higher value than the following adhesive compound with respect to at least one of glass transition temperature (Tg), softening point, and melting point (Tm). The glass transition temperature (Tg) of the resin incorporated in the masking composition is preferably higher than the glass transition temperature of the following adhesive compound from the viewpoint that transfer of glossy film onto the non-recording portion is suppressed. From the viewpoint of dealing with various kinds of the recording medium, the Tg of the resin incorporated in the masking composition is preferably 30° C. or higher, more preferably 70° C. or higher, and further preferably 80° C. or higher.

The content of the resin in the masking composition is preferably 1% by mass or more and 10% by mass or less with respect to the total amount of the masking composition. By using an ink jet method, from the viewpoint of coating the non-recording portion of the recording medium without carrying out overcoat, the content is preferably 2% by mass or more and 8% by mass or less, and more preferably 3% or more.

### 2.1.2. Other Components

### 2.1.2.1. Coloring Materials

The masking composition may contain coloring materials, if necessary.

Examples of the coloring material incorporated in the masking composition include dyes and pigments. Example of the coloring material includes a coloring material which may be used for general inks and is not specifically limited.

Examples of the dyes to be used in the masking composition include various dyes for general ink jet recording such as direct dyes, acidic dyes, edible dyes, basic dyes, reactive dyes, dispersion dyes, vat dyes, solubilized vat dyes, and reactive dispersion dyes.

Examples of the pigments to be used in the masking composition include inorganic pigments and organic pigments.

Examples of the inorganic pigments include carbon blacks. In addition, examples of the organic pigments include azo pigments, polycyclic pigments, dye chelates, nitro pigments, nitroso pigments, and aniline blacks. Examples of colors of pigments include black, yellow, magenta, cyan, and the like.

When the masking composition according to the present embodiment contains coloring materials, the composition may contain plural coloring materials. For example, in addition to basic four colors of yellow, magenta, cyan, and black, deep colors and pale colors in the group of the same color for every color may be combined. In other words, in addition to magenta, Light Magenta as the pale color, Red as the deep color; in addition to cyan, Light Cyan as the pale color and Blue as the deep color; and in addition to black, Gray, Light black as the pale color and Matt Black as the deep color.

The masking composition of the invention may contain white pigments. Examples of the white pigments for the masking composition include oxides of Group IV elements in Periodic Table such as titanium dioxide and zirconium dioxide. Examples of the white pigments include, in addition to metals described above, calcium carbonate, calcium sulfate, zinc oxide, barium sulfate, barium carbonate, silica, alumina (aluminum oxide), kaolin, clay (clay mineral), talc, white clay, aluminum hydroxide, magnesium carbonate, magnesium oxide, and the like, and preferably one or two or more mixture selected from the group consisting of described examples.

When the masking composition contains pigments, the composition may further contain pigment dispersants for dispersing the pigments. Examples of the preferable dispersants include a dispersant generally used for preparing pigment dispersion, for example, a polymer dispersant. Examples of the dispersants include any dispersants generally used for the inks. The content of the pigment dispersants in the masking composition is 5 to 200% by mass, preferably 30 to 120% by mass, with respect to the content of the pigments in the masking composition. The content may be appropriately selected depending on coloring materials to be dispersed.

In order to disperse pigments into dispersion mediums, plural methods such as resin dispersion, self dispersion, or microcapsule-type dispersion may be exemplified, but in the masking composition of the invention any method may be used. When the masking composition according to the present embodiment contains pigments, the average particle size of the pigments in terms of volume is in a range of 10 nm or more and 500 nm or less, more preferably 50 nm or more and 500 nm or less. The average particle size of the pigment in terms of volume may be measured by calculating a particle size accumulation curve by using a light (laser) scattering method or a nitrogen absorption method.

When the masking composition for the present embodiment contains coloring materials, an amount of the coloring material to be added is preferably in a range of 0.1% by mass or more and 25% by mass and more preferably in a range of 0.5% by mass or more and 15% by mass or less.

### 2.1.2.2. Water

The masking composition according to the present embodiment may be a water-based composition having an amount of 50% by mass or more of water or a non-water-based composition having an amount of less than 50% by mass of water. Examples of the water to be used for the masking composition include pure water or ultrapure water such as ion-exchange water, ultrafiltration water, reverse osmosis water or distilled water. Ion or the like may be present in water. In particular, the water sterilized by irradiation of ultraviolet rays or addition of hydrogen peroxide are preferable because the water may suppress generation of fungi or bacteria for a long period of time, and stably maintain the masking composition.

When the masking composition according to the present embodiment contains water, the content of water is preferably 20% by mass or more and 95% by mass or less with respect to the total amount of the masking composition.

A phrase “the content of water is 20% by mass or more and 95% by mass or less” indicates that components other than water is a content of 5% by mass or more and 80% by mass or less. In the specification, components other than water may be referred to as solid content. A phrase “the content of the water is 20% by mass or more and 95% by mass or less” indicates that the solid content of the masking composition is 5% by mass or more and 80% by mass or less.

When the masking composition may be attached to the recording medium by an ink jet method, the masking composition contains water, and thus the masking composition formed on the recording medium may be dried rapidly, while undesirable drying (evaporation of dispersion medium) of the masking composition may be prevented near the nozzles of the ink jet recording device. According to the water-based masking composition, there is also an advantage that the composition has low environment load.

### 2.1.2.3. Surfactant

The masking composition according to the present embodiment may contain surfactants. Examples of the surfactants preferable for the masking composition according to the present embodiment include at least one of an acetylene glycol-based surfactant and a polysiloxane-based surfactant. When these surfactants are blended with an adhesive composition, wettability to the recording surface of the recording medium may be increased.

Examples of the acetylene glycol-based surfactants include 2,4,7,9-tetramethyl-5-decin-4,7-diol, 3,6-dimethyl-4-octin-3,6-diol, 3,5-dimethyl-1-hexin-3-ol, 2,4-dimethyl-5-hexin-3-ol, or the like. In addition, examples of the acetylene glycol surfactants which may be used include commercially available surfactants. Examples of the surfactants include Olfine E1010, STG, and Y and Surfynol 104, 82, 465, 485, TG, and DF110-D (manufactured by Nisshin Chemical Industry Co., Ltd.). Examples of the polysiloxane-based surfactants include a commercially available surfactant. Examples thereof include BYK-347 and BYK-348 (manufactured by BYK Japan KK). Furthermore, the masking composition of this embodiment may contain another surfactant, such as an anionic surfactant, a nonionic surfactant, or an amphoteric surfactant.

When the masking composition according to the present embodiment may contain surfactants, the content of the surfactant is preferably 0.01% by mass or more and 5% by mass or less, and more preferably 0.1% by mass or more and 3% by mass or less with respect to the total amount of the masking composition.

### 2.1.2.4. Polyhydric Alcohol

The masking composition according to the present embodiment may contain polyhydric alcohols.

Examples of the polyhydric alcohols include alkandiols having 4 to 8 carbon atoms such as ethylene glycol, diethylene glycol, triethylene glycol, polyethylene glycol, polypropylene glycol, 1,2- or 1,3-propylene glycol, 1,2- or 1,4-butylene glycol, (1,2-butanediol or 1,4-butanediol), 1,2-petanediol, 1,2-hexanediol, 1,6-hexylene glycol, 1,2-heptanediol, 1,2-octane diol, 2-buten-1,4-diol, 2-methyl-2,4-petanediol; mono, oligo, or polyalkylene glycols having C2-C6 alkylene unit such as diethylene glycol, triethylene glycol, tetraethylene glycol, dipropylene glycol, polyethylene glycol, polypropylene glycol; compounds including a plurality of hydroxyl groups or methyl groups such as 1,2,6-hexanetriol, thioglycol, hexylene glycol, glycerine, trimethylolethane, or trimethylolpropane.

One of the polyhydric alcohol functions is to improve wettability to the recording surface of the recording medium. With respect to the exemplified alkanediol, when the masking composition is applied by an ink jet method, there are effects preventing the masking composition from drying and clogging at the ink jet recording head portion.

When the masking composition according to the present embodiment contains polyhydric alcohols, the content of the polyhydric alcohol is preferably 0.1% by mass or more and 10% by mass or less, and more preferably 1% by mass or more and 8% by mass or less, with respect to the total amount of the masking composition.

The polyhydric alcohol may have several functions which is used alone or in combination thereof. The polyhydric alcohol has a function to suppress drying of the composition other than the function to improve wettability described above. When the composition is applied to the ink jet recording device, there is a higher effect for preventing ink clogging at the ink jet recording head portion. As for the polyhydric alcohol, the number of hydroxyl group in one molecule is appropriately selected, if necessary, because a compound in which the amount of the hydroxyl groups is larger than that of the hydrophobic part has water-capturing and composition-drying inhibition effects.

### 2.1.2.5. Organic Solvent

The masking composition may contain organic solvents.

Examples of the organic solvents include water soluble organic solvent. According to the water soluble organic solvent, without considerably changing features of the masking composition, viscosity may be easily controlled. Examples of the specific organic solvents include C1-C4 alcohols such as methanol, ethanol, n-propanol, isopropanol, n-butanol, isobutanol, sec-butanol, t-butanol; amides such as N,N-dimethylformamide, N,N-dimethylacetamide; heterocyclic ketones such as 2-pyrrolidone, N-methyl-2-pyrrolidone, hydroxyethyl-2-pyrrolidone, 1,3-dimethylimidazolidine and 1,3-dimethylhexahydropyrimid-2-on; ketones or ketoalcohols such as acetone, methylethylketone, 2-methyl-2-hydroxypentan-4-on, and acetonylacetone; cyclic ethers such as tetrahydrofurane and dioxane; glycolethers (C1-C4 monoalkylether as polyhydric alcohol) such as ethylene glycolmonomethylether, ethylene glycolmonobutylether, diethylene glycolmonomethylether, diethylene glycolmonoethylether, diethylene glycolmonobutylether(butylcarbitol), triethylene glycolmonomethylether, triethylene glycolmonoethylether, propylene glycolmonomethylether, dipropylene glycolmonomethylether, dipropylene glycolmonoethylether, propylene glycolmonobutylether, dipropylene glycolmonobutylether, triethylene glycolmonobutylether; esters such as γ-butyrolactone, triethyl phosphate; furfurylalcohol; tetrahydrofurfurylalcohol; thiodiglycol; trimethylglycine; or dimethylsulfoxide, or the like.

For example, the exemplified organic solvents also contain solid materials at room temperature such as trimethylolpropane or trimethylglycine. However, the material or the like exhibits water solubility even at a solid state, and water solution containing the material may expect an effect on water soluble organic solvent.

Among the exemplified organic solvents, for example, polyhydric alcohols, ketones, esters, furfurylalcohols, tetrahydrofurfurylalcohol, thiodiglycol, and trimethylglycine has lower vapor pressure than that of pure water, or a solid at room temperature, so that the organic solvent has low volatility, and thus high moisture property increases. Therefore, the organic solvent has a good effect as a moisturizer, when the organic solvent is incorporated in the masking composition, an effect suppressing evaporation of moisture from the masking composition may be expected.

Examples of the moisturizers include, in addition to the organic solvents described above, sugars such as maltitol, sorbitol, gluconolactone, maltose, the sugars may be preferably used for the masking composition.

The exemplified compounds as the organic solvent is the same as the exemplified compounds as the polyhydric alcohol, but the compounds serves as both organic solvent and polyhydric alcohol. When the masking compound contains organic solvents, the content of the total sum of the organic solvent and polyhydric alcohol is preferably 1% by mass or more and 80% by mass or less, with respect to the total amount of the masking composition. Considering viscosity, moisture retention, and permeation to the recording medium of the masking composition, and bleeding, the content is preferably 2% by mass or more and 50% by mass or less.

Among the polyhydric alcohols, C4-C8 1,2-alkanediols such as 1,2-butanediol, 1,2-petanediol, 1,2-hexanediol, 1,2-heptanediol, and 1,2-octane diol are preferable because the alcohols have an excellent effect that allows permeation of the masking composition into the recording medium to increase. Among these alcohols, 1,2-hexanediol, 1,2-heptanediol, and 1,2-octanediol which have 6 to 8 carbon atoms are more preferable because the alcohols have an excellent effect that allows permeation of the masking composition into the recording medium to increase. Among the organic solvents, glycolethers has a good effect as a permeation accelerator. When the glycolethers are blended with the masking composition, permeation into the recording medium may be increased. In the case where the masking composition contains coloring materials, when the masking composition is bonded to adhesive compositions or other ink compositions described below on the recording medium, bleeding between compositions may be reduced, and clear image may be obtained.

Examples of the masking composition according to the present embodiment include, as other components, additives, for example, fixing agent such as water soluble rosin, preservative and fungicide such as sodium benzoate, antioxidant such as allophanates, moisturizer, ultraviolet absorber, chelating agent, oxygen absorber, permeation solvent, pH adjuster, preservative agent, fungicide, urea-based compound, drying inhibitors such as alkanolamine (triethanolamine or the like) and thiourea. The additives may be used singly or in combination of two or more additives.

The masking composition may contain, if necessary, a leveling additive, a matting agent, polyester-based resin, polyurethane-based resin, vinyl-based resin, acryl-based resin, rubber resin or waxes for the control of physical properties in the attached film.

### 2.1.3. Properties and Functions of Masking Composition

Viscosity or colors of the masking composition may be designed freely. According to suitable selection of the components, for example, general ink jet ink for ink jet may contain resin. When the masking composition is applied by an ink jet method, the masking composition has a viscosity at 20° C. of 2 to 10 mPa·s, and more preferably 3 to 5 mPa·S. When the viscosity at 20° C. of the masking composition is in the range described above, the masking composition from the nozzle is appropriately ejected, and flight curve or flying of the masking composition may be reduced. The viscosity of the masking composition may be appropriately adjusted by changing blending, types, and the composition ratio of components described above.

When the masking composition contains resins, and thereby the glossy film is transferred onto the recording portion of the recording medium from the glossy film-formed sheet, transfer of the glossy film onto the non-recording portion may be suppressed. The masking composition may be attached to the recording portion of the recording medium. At this time, in the recording portion, adhesive compounds are attached onto the masking composition.

When the masking composition is a clear ink having no coloring materials, it is preferable that the non-recording portion of the recording medium exhibits the afore-mentioned function without changing hues thereof. Furthermore, when the masking composition contains coloring materials, hues of the recording medium are allowed to be changed. In addition, by adjusting composition of the masking composition, the surface of the recording medium may have gloss or high abrasion resistance.

### 2.2. Adhesive Composition

The adhesive composition is attached to the recording portion of the recording medium by an ink jet method. The adhesive composition contains at least an adhesive compound.

### 2.2.1. Adhesive Compound

Examples of the adhesive compounds incorporated in the adhesive composition include monomers, oligomers, and polymers generally used for adhesives such as acryl-based, urethane-based, vinyl chloride-based, and vinyl acetate-based, and modified compounds thereof.

Examples of the specific adhesive compounds include vinyl chloride-based emulsion (Tg=−2° C.), vinyl chloride-based emulsion (Tg=42° C.) (commercially available vinyl chloride-based adhesive manufactured by Nisshin Chemical Industry Co., Ltd.), Movinyl 727 (Tg=5° C.), Movinyl 718A (Tg=−6° C.), Movinyl 752 (Tg=15° C.), Movinyl 7525 (Tg=−16° C.), Movinyl 745 (Tg=21° C.) (for example, commercially available acryl-based adhesive manufactured by Nippon Synthetic Chemical Industry Co., Ltd.); Superflex 840 (Tg=5° C.), Superflex 500M (Tg=−39° C.) (for example, commercially available urethane-based adhesive manufactured by Dai-ichi Kogyo Seiyaku Co., Ltd.), or the like.

In the case where emulsion is used as the adhesive compound, the emulsion may be produced by synthesis. For example, the emulsion may be obtained by polymerizing the monomer of resins using methods such as emulsion polymerization, or suspension polymerization.

The glass transition temperature (Tg) of the adhesive compound is preferably −10° C. or higher and 70° C. or lower, and more preferably 10° C. or higher and 70° C. or lower, from the viewpoint of ease operation in the heating step in the recording method according to the present embodiment and simple constitution of the device. The adhesive compound incorporated in the adhesive composition has a lower value than the resin incorporated in the masking composition, with respect to at least one of Tg, softening point, and Tm. Furthermore, it is preferable that Tg of the adhesive compound incorporated in the adhesive composition is lower than Tg of the resin incorporated in the masking composition.

The adhesive composition may exhibit adhesion by heating. Furthermore, the adhesive composition may use a compound which exhibits adhesion by reaction. If necessary, the adhesive composition may contain additives such as polymerization initiators, reaction aids, antioxidant, ultraviolet absorbers, and fillers. The adhesive composition may contain two or more of the adhesive compounds described above.

### 2.2.2. Other Components

The adhesive composition may contain at least one of water, surfactants, polyhydric alcohols and organic solvents. These components are the same as those in Chapters “2.1.2.2. Water”, “2.1.2.3. Surfactant”, “2.1.2.4. Polyhydric Alcohol”, and “2.1.2.5. Organic Solvent”, described in the afore-mentioned masking composition, except that the masking composition is replaced with the adhesive composition, of which the detailed description is not indicated.

### 2.2.3. Physical Properties and Functions of Adhesive Composition

The adhesive composition may be prepared so as to attach to the recording medium by an ink jet method. Examples of the conditions in which the adhesive composition may be applied by an ink jet method include viscosity. The adhesive composition has a viscosity at 20° C. of 2 to 10 mPa·s, and more preferably 3 to 5 mPa·S. When the viscosity at 20° C. of the adhesive composition is in the range described above, the adhesive composition is appropriately ejected from the nozzle, and curve flight or flying of the adhesive composition may be reduced, which is preferable for the recording method according to the present embodiment.

The adhesive composition may be heated at higher temperature than that of at least one of glass transition temperature and softening point of the adhesive compound and thus exhibit adhesion. Therefore, the adhesive composition is heated such that the adhesive composition is brought into contact with the glossy film, and the glossy film is attached to the recording portion of the recording medium.

### 3. Method for Recording Glossy Image

The recording method according to the present embodiment includes a method for recording a glossy image on a recording medium 10 of which a recording surface 16 includes a recording portion 12 having the glossy image recorded and a non-recording portion 14 having glossy image non-recorded, the method includes the steps of attaching a resin-containing masking composition 20 to the non-recording portion 14, attaching an adhesive composition 30 to the recording portion 12 by an ink jet method, bringing the recording medium 10 into contact with a glossy film 42 formed sheet 40 such that the recording surface 16 of the recording medium 10 faces the glossy film 42 formed surface of the sheet 40, heating the adhesive composition 30, and peeling off the recording medium 10 and the sheet 40.

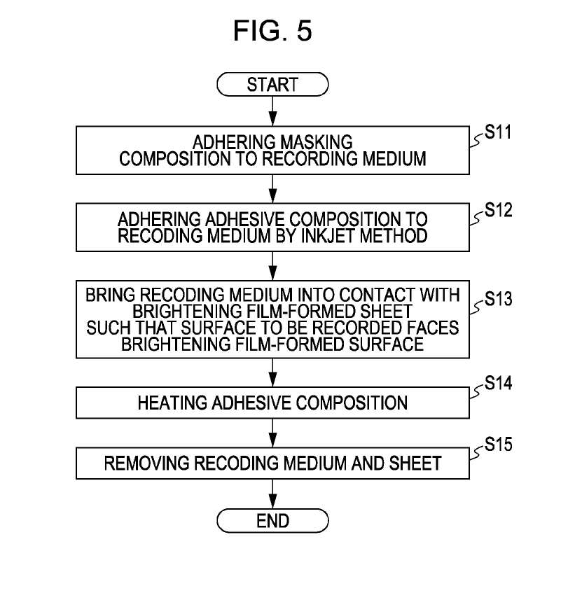

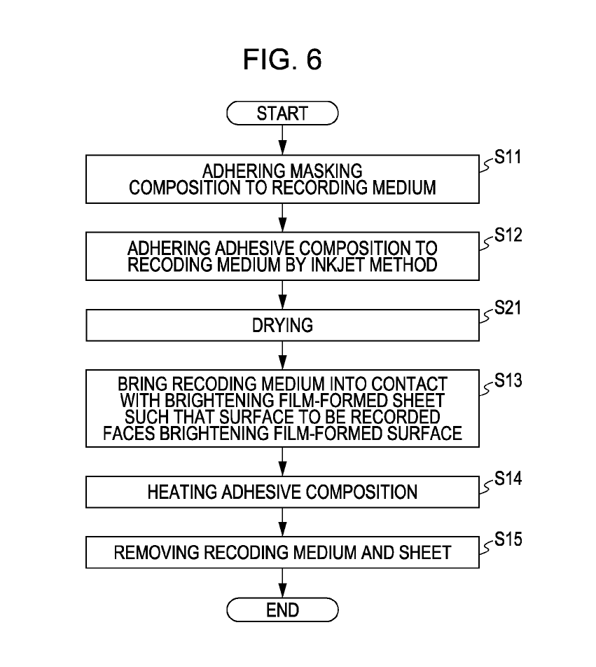

FIGS. 1 to 4 are schematic views illustrating respective processes of the method for recoding the glossy image according to the present embodiment. FIGS. 5 and 6 are flowcharts showing one example of the method for recording the glossy image according to the present embodiment.

### 3.1. Process for Attaching the Masking Composition

The recording method according to the present embodiment includes the process of attaching the masking composition 20 to the recording medium 10. (Step S11 of FIGS. 5 and 6)

As shown in FIG. 1, by the process, the mask layer 22 is formed on the non-recording portion 14 in the recording surface 16 of the recording medium 10. The thickness of the mask layer 22 which may be formed is 50 nm or higher and 5 μm or lower. The flat size (area) or shape of the mask layer 22 is not specifically limited. The mask layer 22 may be formed on the recording portion 12 of the recording medium 10. The mask layer 22 may be formed on the whole of the recording surface 16 of the recording medium 10, or may be formed on only the non-recording portion 14 in the recording surface 16 of the recording medium 10. Furthermore, in a case where the sheet 40 in which the glossy film 42 to be contacted subsequently is formed includes the portion where the glossy film 42 is not formed, the mask layer 22 may not be formed on a region corresponding to the portion. In the recording portion 12 in the left side of the example shown in FIGS. 1 to 4, the mask layer 22 is formed. In a case where the mask layer 22 is formed on the recording portion 12 as in the left side of the example shown in FIGS. 1 to 4, the process of attaching the masking composition 20 is carried out before the process attaching the adhesive composition 30. In addition, as in the right side of the example shown in FIGS. 1 to 4, in a case where the mask layer 22 is not formed on the recording portion 12, the process of attaching the masking composition 20 and the process of attaching the adhesive composition 30 are carried out in an arbitrary order.

As for the process attaching the masking composition 20, a dip coat, a spray coat, and a bar coat may be used. In addition, the masking composition 20 may be attached by an ink jet method. In a case where the process is carried out by an ink jet method, as shown in the Figure, the process includes a case where the mask layer 22 is formed on the recording portion 12 and a case where the mask layer 22 is not formed on the recording portion 12.

One of the mask layer 22 functions is to make transfer of the glossy film 42 onto the recording medium 10 difficult. Such an effect of the mask layer 22 is more remarkable in a case where the recording surface 16 of the recording medium 10 is a coat layer containing materials having a Tg of 70° C. or lower.

### 3.2. Process for Attaching the Adhesive Composition

The method for recording the glossy image according to the present embodiment includes the process attaching the adhesive composition 30 to the recording portion 12 of the recording medium 10 by an ink jet method. (Step S12 of FIGS. 5 and 6)

As shown in FIG. 2, by the process, the adhesive layer 32 is formed on the recording portion 12 of the recording medium 10. In a case where the mask layer 22 is formed on the recording portion 12, the adhesive layer 32 is formed on the mask layer 22 of the recording portion 12. The thickness of the adhesive layer 32 may be designed to be 50 nm or higher and 5 μm or lower.

The adhesive layer 32 may be developed without any treatment. For example, the adhesion of the adhesive layer 32 may be developed when stimulation of at least one of temperature (thermal), pressure, and radiation (light or the like) is applied to the adhesive layer 32.

One of the adhesive layer 32 functions is to remove the glossy film 42 from the glossy film 42 formed sheet 40, and transfer the glossy film 42 onto the recording medium 10 as a transfer target.

3.3. Process for Contacting Recording Medium with Sheet

The method for recording the glossy image according to the present embodiment includes a process for bringing the glossy film 42 formed sheet 40 into contact with the recording medium 10 such that the recording surface 16 of the recording medium 10 faces the glossy film 42 formed surface of the sheet 40 (Step S13 of FIGS. 5 and 6)

As shown in FIG. 3, by the process, the adhesive layer 32 formed on the recording medium 10 is brought into contact with the glossy film 42 formed on the sheet 40. As one example shown in Figures, the glossy film 42 is also brought into contact with the mask layer 22. An embodiment bringing the adhesive layer 32 into contact with the glossy film 42 is not specifically limited, but superposition of the sheet 40 and the recording medium 10 may be pressed by a press or a roller, for example. In addition, in a case where the adhesive composition 30 exhibits adhesion by applying pressure, a pressing embodiment is preferably used in the process. In this case, a required pressure may be applied.

In addition, the process may be performed by heating at least one of the recording medium 10 and the sheet 40 using an appropriate heating unit. In a case where the process is performed by heating at least one of the recording medium 10 and the sheet 40, the following chapter “3.4. Process for Heating the Adhesive Composition” can be performed.

### 3.4. Process for Heating the Adhesive Composition

The method for recording the glossy image according to the present embodiment includes a process for heating the adhesive composition 30. (Step S14 of FIGS. 5 and 6) The adhesive layer 32 is formed with the adhesive composition 30 by the Chapter “3.2. Process for Attaching the Adhesive Composition”.

The process may be performed by, for example, methods such as hot air, heating wires, infrared ray heaters, and electromagnetic heating. Furthermore, the process may be performed at the same timing as the Chapter “3.3. Process for Contacting Recording Medium with Sheet” or may be performed after the process for contacting the recording medium 10 with the sheet 40. In other words, for example, in the process for contacting the recording medium 10 and the sheet 40, in a case of using a press or a roller, the process can be performed by using the heated press or roller. In addition, after the process for contacting the recording medium 10 with the sheet 40, the process may be performed using separate devices for heating.

By heating of the process, the adhesive layer 32 (adhesive composition 30) is heated to a higher temperature than glass transition temperature (Tg) in a case where the adhesive composition 30 exhibits adhesion by using the phase transition of glass state and rubber state. In addition, in a case where the adhesive composition 30 exhibits adhesion by using reaction (for example, curing reaction), the adhesive layer is heated to a higher temperature than the reaction temperature. Furthermore, in a case where the adhesive composition 30 exhibits adhesion at a higher temperature than the softening point, the adhesive layer is heated to a higher temperature than softening point. In other words, in the process the adhesive layer 32, the adhesive layer is heated to a higher temperature than at least one of glass transition temperature (Tg), softening point and melting point (Tm) of the adhesive compound. On the other hand, by the process, the mask layer 22 (masking composition 20) may be heated. Since the resin incorporated in the mask layer 22 has a higher temperature than the adhesive compound, with respect to at least one of Tg, softening point, and Tm, the temperature of the process is designed such that the resin of the mask layer 22 has no adhesion.

By the process, the recording medium 10 is attached to the glossy film 42. In addition, in a case where the mask layer 22 is formed on the recording portion 12 of the recording medium 10, the adhesive layer 32 is attached to the mask layer 22. Furthermore, the mask layer 22 is in close contact with the recording medium 10. It is designed that the adhesion between the recording medium 10 or the mask layer 22 and the glossy film 42 is at least higher than the adhesion between glossy film 42 and sheet 40 together with the following process.

### 3.5. Process for Peeling the Recording Medium and Sheet

The method for recording the glossy image according to the present embodiment includes a process for peeling the recording medium 10 and the sheet 40. (Step S15 of FIGS. 5 and 6)

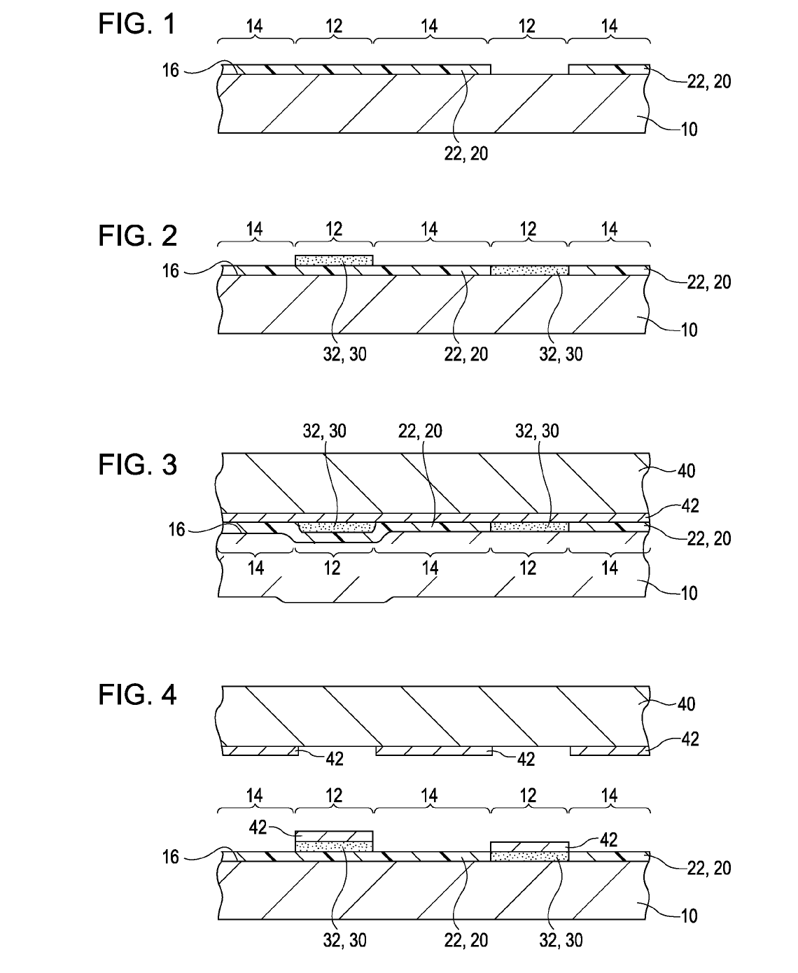

As shown in FIG. 4, by the process, the glossy film 42 is transferred onto the recording medium 10 from the sheet 40. A portion of the glossy film 42 which is attached to the adhesive layer 32 is transferred. In an embodiment of removal, for example, thickness of the glossy film 42, adhesion between the glossy film 42 and the sheet 40, adhesion between the adhesive layer 32 and the glossy film 42, an embodiment contacting the recording medium 10 with the sheet 40, and peel angle of the process are appropriately designed.

The process can be performed by using general peelers or the like. In addition, in the process, transfer of the sheet 40 or the recording medium 10 is appropriately carried out by suitably placing a roller or the like. Furthermore, for example, the process may be performed with hands of a user.

It is preferable that the process be performed after cooling the adhesive layer 32 after “heating process”. For example, in this case, after the heating process, the cooling process may be placed. Examples of the cooling process include a process for setting a cooling period or cooling the adhesive layer 32 by using cooling units (cooling rollers or the like).

### 3.6. Drying Process

The method for recording the glossy image according to the present embodiment may include a drying process. (Step S21 of FIG. 6) The drying process is performed if necessary.

The drying process can be performed between “process for attaching the adhesive composition (Step S12)” and “process for contacting the recording medium with the sheet”. The drying process is a process of drying the adhesive composition 30 (adhesive layer 32) attached to the recording medium 10. The drying process can be performed by hot air, heating wires, infrared heaters, electromagnetic heating, or the like.

The drying process removes water and solvent from the adhesive composition 30. In other words, the drying process may remove components such as water and solvent from the adhesive composition 30 immediately after being attached to the recording medium 10 (immediately after being ejected from the nozzle of ink jet). When the drying process is performed, the adhesive composition 30 (adhesive layer 32) can have high adhesion and transfer failure may be suppressed.

With respect to degree of the drying in the drying process, the amount of the adhesive composition 30 immediately after being attached to the recording medium 10 (immediately after being ejected from the nozzle of ink jet) is for example removed by 10% or more and 99% or less, and more preferably 40% or more and 95% or less.

In a case where the recording method according to the present embodiment includes a drying process, the glossy image having higher adhesion may be formed on the recording medium 10.

### 3.7. Coloration Process

The present embodiment, if necessary, may include a coloration process after the process for peeling off the recording medium 10 and the sheet 40. The coloration process refers to a process for providing coloration inks containing coloring materials. By using this coloration process, image with hues provided for the transferred glossy film 42 or hues provided for the non-recording portion 14 can be formed. With respect to the coloring materials, the coloring materials described in the Chapter “2.1.2.1 Coloring Materials” can be preferably used.

### 3.8. Action and Effect

With respect to the recording method according to the present embodiment, the glossy image can be accurately and easily formed on the recording medium by performing the processes described above. According to the recording method according to the present embodiment, glossy film may be transferred onto the recording portion of the recording medium, and transfer of the glossy film onto the non-recording portion of the recording medium may be suppressed.

### 4. Recording Device

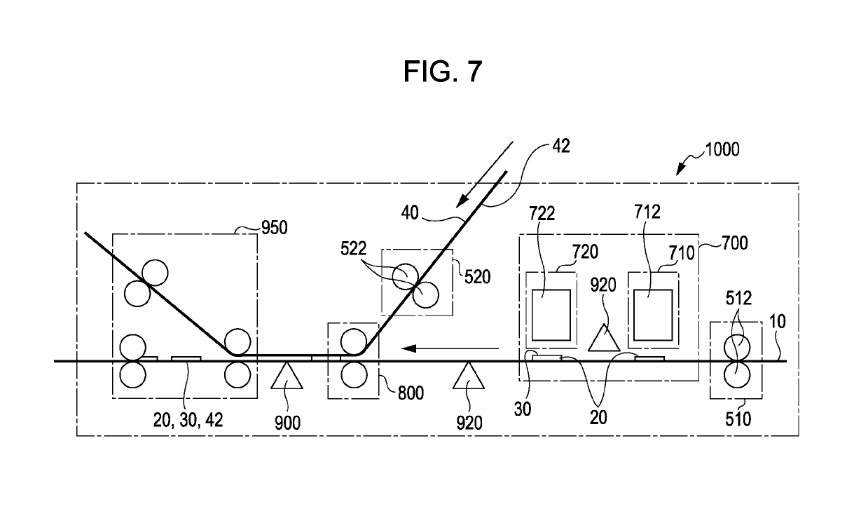

Hereinafter, one example of the recording device which can be preferably used for the aforementioned recording method is described. FIG. 7 is a schematic view illustrating one example of the recording device to be used for the method for recording the glossy image according to the present embodiment.

The recording device 1000 according to the present embodiment includes a first conveying unit 510 for conveying the recording medium 10, a second conveying unit 520 for conveying the glossy film 42 formed sheet 40, a first recording unit 710 for attaching the masking composition 20 to the recording medium 10, a second recording unit 720 for attaching the adhesive composition 30 to the recording medium 10, a contacting unit 800, a heating unit 900, and a removing unit 950.

### 4.1. First Conveying Unit and Second Conveying Unit

The first conveying unit 510 conveys the recording medium 10. The second conveying unit 520 conveys the glossy film 42 formed sheet 40.

The first conveying unit 510 can be configured to have a roller 512. The first conveying unit 510 may include plural rollers 512. As an example shown in the Figure, in a direction of the recording medium 10 to be conveyed (indicated by an arrow in the Figure), the first conveying unit 510 is located in the upstream of the first recording unit 710, which is not limited. Positions or numbers to be placed are optionally set as long as the recording medium 10 may be transferred.

For example, the second conveying unit 520 can be configured to have a roller 522. The second conveying unit 520 may include plural rollers 522. As an example shown in the Figure, in a direction of the sheet 40 to be conveyed, the second conveying unit 520 is located in the upstream of the second recording unit 720, which is limited. With respect to the recording medium 10, positions or numbers to be placed are optionally set as long as the second conveying unit 520 is placed to stack the glossy film 42 formed sheets 40.

The first conveying unit 510 and the second conveying unit 520 may have paper feeding rolls, paper feeding trays, paper ejection rolls, paper ejection trays, and various platens. The first conveying unit 510 and the second conveying unit 520 are configured to stack the recording medium 10 and the glossy film 42 formed sheet 40.

The recording medium 10 to be conveyed by the first conveying unit 510 is conveyed to a position where the masking composition the adhesive composition are attached by the first recording unit 710 and the second recording unit 720, respectively. In addition, by the second conveying unit 520, the glossy film 42 formed sheet 40 is conveyed to a position where the recording medium 10 is brought into contact with the glossy film 42 formed sheet 40 by the contacting unit 800.

FIG. 7 shows one example of a case where both the recording medium 10 and the glossy film 42 formed sheet 40 are a continuous body. Even though at least one of the recording medium 10 and the glossy film 42 formed sheet 40 may be a single sheet, the first conveying unit 510 and the second conveying unit 520 are appropriately configured so that the recording medium 10 can be conveyed.

The first recording unit 710 is caused to attach the masking composition 20 to the recording medium 10. The second recording unit 720 is caused to attach the adhesive composition 30 to the recording medium 10. The first recording unit 710 and the second recording unit 720 may use separate ink jet mode recording heads 712 and 722, or may be integrally configured by a ink jet mode recording head 700.

### 4.2. Contacting Unit, Heating Unit and Removing Unit

The contacting unit 800 brings the recording medium 10 into contact with the glossy film 42 formed sheet 40. Examples of the constitution of the contacting unit 800 include pressing rollers.

The heating unit 900 in a direction of the recording medium 10 to be conveyed (indicated by an arrow in the Figure) is located in the downstream of the contacting unit 800. The heating unit 900 can be configured to have a heating roller. In addition, examples of the pressing unit having a heating device include constitutions of the major portion of general laminator devices. Furthermore, the heating unit 900 in a direction of the recording medium 10 to be conveyed may be located at the same position as the contacting unit 800. For example, the contacting unit 800 has a heating device, and thereby the heating device can be used as the heating unit 900.

Then, the removing unit 950 separates the recording medium 10 from the glossy film 42 formed sheet 40. The removing unit 950 can use the known removing units, but examples thereof include inclined embankment separation and reader roller separation with friction. By the removing unit 950, as shown in the Figure, glossy film 42 is transferred onto the recording medium 10 to form a glossy image.

In addition, the recording device 1000 may include the drying unit 920 between the second recoding unit 720 and the contacting unit 800.

The recording device 1000 according to the present embodiments described above is preferable for the method for recording the glossy image according to the present embodiment.

### 5. Experimental Examples

The invention will be specifically described below by way of some Experimental Example, and the scope of the invention is not limited.

### 5.1. Composition

The following each composition was prepared as a composition attached to the recording medium.

40 parts of a polymer dispersant (copolymerized in a mass ratio of methacrylic acid/butylacrylate/styrene/hydroxyethylacrylate=25/50/15/10, weight average molecular weight 12,000) was charged into the mixture of 7 parts of potassium hydroxide, 23 parts of water, and 30 parts of triethylene glycol-mono-n-butylether, heated and stirred at 80° C., followed by carrying out polymerization to prepare a polymer dispersant varnish. To 2.4 kg of this varnish (solid content 43%) were added 3.0 kg of a yellow pigment (Pigment Yellow 155), 1.5 kg of ethylene glycol and 8.1 kg of water, followed by carrying out stirring with a mixing and stirring device, and then premixing was carried out. This pigment dispersed mixture was dispersed by multi-passes mode in a horizontal beads mill equipped with a multi-disks type impeller having an effective volume of 1.5 L charged to 85% with 0.5 mm zirconia beads therein. Specifically, two passes was carried out in an ejecting amount of 30 L/h at a beads peripheral speed of 8 m/s to obtain a pigment dispersed mixture. Subsequently, this pigment dispersed mixture was circulated and dispersed in a horizontal annular type beads mill having an effective volume of 1.5 L charged to 95% with 0.05 mm zirconia beads therein. Screening was made by using 0.015 mm zirconia beads and 10 kg of pigment dispersed mixture was subjected to dispersion in a circulation amount of 300 L/h at a beads peripheral speed of 10 m/s for 4 hours to obtain a yellow pigment dispersion.

Then, the yellow pigment was added in the content indicated in Table 1, and a surfactant, a solvent, a styrene-acryl copolymer, and ion-exchanged water described in Table 1 were added to obtain a masking composition 1 and a masking composition 2. Similarly to the afore-mentioned method, clear inks were produced without the addition of the yellow pigment, and each of the clear inks was used as a masking composition 3 and a masking composition 4. In addition, the surfactant used Surfynol DF110D manufactured by Nisshin Chemical Industry Co., Ltd. The styrene-acryl copolymer used JONCRYL 734 or JONCRYL 7640 manufactured by BASF Japan Ltd. having a glass transition temperature (Tg) of 30° C. or 85° C., respectively.

TABLE 1

| | | | | | | Adhesive |
|---|---|---|---|---|---|---|
| | | | | | | Compo- |
| | | Masking Composition | | | | sition |
| (% by mass) | | 1 | 2 | 3 | 4 | — |
| Pigment | Pigment | 4 | 4 | — | — | — |
| | Yellow 155 | | | | | |
| Resin | Styrene-acryl | 3 | | 7 | | — |
| | Copolymer | | | | | |
| | (Tg = 30° C.) | | | | | |
| | Styrene-acryl | | 3 | | 7 | |
| | Copolymer | | | | | |
| | (Tg = 85° C.) | | | | | |
| Adhesive | Movinyl 727 | — | — | — | — | 10 |
| Compound | (Tg = 5° C.) | | | | | |
| | acryl-based | | | | | |
| Surfactant | Surfynol | 1 | 1 | 1 | 1 | 1 |
| | DF110D | | | | | |

| | | | | | |
|---|---|---|---|---|---|
| Propyleneglycol | 8 | 8 | 12 | 12 | 11 |
| 1,2-hexanediol | 5 | 5 | 5 | 5 | 5 |
| 2-pyrrolidone | 2 | 2 | 2 | 2 | 2 |
| ion exchanged water | Bal- | Bal- | Bal- | Bal- | Bal- |
| | ance | ance | ance | ance | ance |

On the other hand, Movinyl 727 (Tg=5° C.), commercially available acryl-based adhesive (manufactured by Nippon Synthetic Chemical Industry Co., Ltd.) was added and mixed sufficiently, as indicated in Table 1 to obtain an adhesive composition.

### 5.2. Recording Medium and Glossy Film-Formed Sheet

The recording medium used polyethylene terephthalate film (PET 50A, manufactured by Lintec Corporation), polyethylene terephthalate film (PETC 50, manufactured by Oji Tac Co., Ltd.), polypropylene-based film (PPC 50, manufactured by Oji Tac Co., Ltd.), and SY 51M (manufactured by UPM RAFLATEC Inc.). As for the glossy film-formed sheet, a silicon-based releasing agent and aluminum deposited film were used.

### 5.3. Recording Device

The ink tank of an ink jet printer, mode PX-G5500 manufactured by Seiko Epson Corporation was charged with respective masking composition and adhesive composition. The masking composition and the adhesive composition were printed sequentially on the recording medium in an amount of 45 mg/inch. At this time, the adhesive composition was printed on the test patterns and the masking composition was printed on a portion other than test patterns. The glossy film-formed surface of the sheet was bonded to a printed surface such that the glossy film-formed surface of the sheet faces a printed surface and passed through a commercially available laminator. In addition, for transfer, JOL-DIGITAL-4JOL0 (manufactured by Japan Office Laminator Inc.) was used, a thermal pressing roller was adjusted to have a temperature of 130° C., a pressure of 30 kg/cm², and a velocity of 20 cm/s. Then, the glossy film was removed with hands of a user and evaluated.

The masking composition and recording medium used in each Experimental Example are shown in Table 2.

### 5.4. Evaluation of Image Transferability

The image transferability was evaluated in accordance with the following criteria, and the evaluation result thereof is described in Table 2.

A: Glossy film was accurately transferred onto only a test pattern portion.

B: Glossy film was slightly transferred onto near a test pattern portion.

C: Glossy film was transferred onto the portion other than a test pattern portion.

TABLE 2

| | | | Experimental Example | | | | | |
|---|---|---|---|---|---|---|---|---|
| | | | 1 | 2 | 3 | 4 | 5 | 6 |
| Types of masking composition | | | 1 | 2 | 3 | 4 | None | None |
| Image | Types of | PET 50A | A | A | B | A | C | C |
| transfer- | recording | PETC 50 | A | A | B | A | C | C |
| ability | medium | PPG 50 | A | A | B | A | C | C |
| | | SY 50M | A | A | B | A | C | C |

### 5.5. Evaluation Result

According to Table 2, use of the masking composition (Experimental Examples 1 to 4) indicated a good result. It is considered that this is because adhesion of the masking composition is lower than the adhesion of the adhesive composition, in the experimental conditions according to the present embodiment. In addition, when the masking composition is a clear ink and has a high content of resin, higher Tg of the resin (styrene-acryl copolymer) exhibited more excellent result.

On the other hand, when the masking composition is not used (Experimental Examples 5 and 6), the glossy film was also transferred onto the portion other than the test pattern. It is considered that this is because a coat layer on the surface of the used recording medium exhibits adhesion in the experimental conditions.

As described above, according to the recording method of the invention, in the various types of the recording medium, it was found that the glossy image can be accurately and easily formed on the recording medium.

The invention is not limited to the afore-mentioned embodiments and various modification and variations can be made. For example, the invention includes constitutions substantially similar to the constitutions described in the present embodiments (for example, constitutions similar to functions, methods, and results; or constitutions similar to objects and effects). In addition, the invention includes constitutions changing non-essential portion from the constitutions described in the present embodiment. Furthermore, the invention includes constitution having actions and effects and constitution capable of achieving objects similar to the constitutions described in the present embodiment. In addition, the invention includes constitution adding known techniques in the constitutions described in the present embodiments.

What is claimed is:

1. A method for recording a glossy image on a recording medium of which a recording surface includes a recording portion having the glossy image recorded and a non-recording portion having the glossy image non-recorded, the method comprising the steps of:
attaching a resin-containing masking composition to the non-recording portion;
attaching an adhesive composition to the recording portion by an ink jet method;
bringing the recording medium into contact with a glossy film-formed sheet such that the recording surface of the recording medium faces the glossy film-formed surface of the sheet,
heating the adhesive composition; and
peeling off the recording medium and the sheet.

2. The method according to claim 1, wherein the adhesive composition contains an adhesive compound and the adhesive compound has a glass transition temperature of −10° C. or higher and 70° C. or lower.

3. The method according to claim 1, wherein the masking composition contains the resin of 3% by mass or more.

4. The method according to claim 3, wherein the resin has a glass transition temperature of 70° C. or higher.

5. The method according to claim 3, wherein the resin is at least one of acryl-based, urethane-based, and polyester-based, and incorporated as emulsion in the masking composition.

6. The method according to claim 1, wherein the recording surface of the recording medium is a coat layer, and the coat layer contains a material having a glass transition temperature of 70° C. or lower.

7. The method according to claim 1, further comprising a drying step between the step attaching the adhesive composition and the step bringing the recording medium into contact with the sheet, wherein in the drying step, the amount of the adhesive composition attached to the recording medium is reduced by 40% or more and 95% or less.

8. The method according to claim 1, the masking composition is attached to the non-recording portion by an ink jet method without substantial incorporation of coloring materials.
